(19) United States
(12) Patent Application Publication
(10) Pub. No.: US 2024/0359141 A1
(43) Pub. Date: Oct. 31, 2024

(54) MEMBRANE ASSEMBLY AND SEPARATION MEMBRANE MODULE

(71) Applicant: NGK INSULATORS, LTD., Nagoya-Shi (JP)

(72) Inventors: Kazuki IIDA, Nagoya-City (JP); Yukinari SHIBAGAKI, Obu-City (JP); Kosuke NAKAGAWA, Nagoya-City (JP); Sota MAEHARA, Nagoya-City (JP); Hirofumi KAN, Nagoya-City (JP)

(73) Assignee: NGK INSULATORS, LTD., Nagoya-Shi (JP)

(21) Appl. No.: 18/769,525

(22) Filed: Jul. 11, 2024

Related U.S. Application Data
(63) Continuation of application No. PCT/JP2023/016843, filed on Apr. 28, 2023.

(30) Foreign Application Priority Data
Apr. 28, 2022 (JP) 2022-074984

(51) Int. Cl. B01D 69/04; B01D 39/20; B01D 71/02

(52) U.S. Cl. CPC B01D 69/04; B01D 39/2068; B01D 71/024; B01D 2201/291

(57) ABSTRACT

A membrane assembly is configured to be housed in a tubular housing. The membrane assembly includes a columnar membrane structure, an annular first flange surrounding a first end portion of the membrane structure, a first intermediate portion arranged between a first end surface of the membrane structure and the housing, and a first bonding material interposed between the first flange and the membrane structure and between the first intermediate portion and the membrane structure.

### CROSS-REFERENCE TO RELATED APPLICATION

This is a continuation of PCT/JP2023/016843, filed Apr. 28, 2023, which claims priority from Japanese Application No. 2022-074984, filed Apr. 28, 2022 the entire content of which is hereby incorporated by reference.

### TECHNICAL FIELD

The present invention relates to a membrane assembly and a separation membrane module.

### BACKGROUND ART

Separation membrane modules including a housing and a columnar membrane structure housed in the housing are conventionally known. Examples of the membrane structure include: a separation filter (see, for example, WO 2018/180095) configured to separate a predetermined component from a fluid mixture with use of a separation membrane; and a reactor (see, for example, JP 2018-008940A) configured to separate a product generated through a conversion reaction for converting a source gas into a liquid fuel with use of a separation membrane.

### SUMMARY

Incidentally, a permeate-side space for collecting a component that has passed through a separation membrane needs to be provided between the membrane structure and the housing, and therefore, it is necessary to produce a membrane assembly by attaching a flange to an end portion of the membrane structure with use of a bonding material.

In order to assure seal characteristics between the flange and the membrane structure, a predetermined seal length is necessary, but if a seal length in the longitudinal direction is increased, internal stress applied to the bonding material increases, and accordingly, reliability of the seal decreases.

An object of the present invention is to provide a membrane assembly and a separation membrane module that can improve reliability of a seal formed by a bonding material between a flange and a membrane structure.

A membrane assembly according to a first aspect of the present invention is configured to be housed in a tubular housing. The membrane assembly includes a columnar membrane structure, an annular first flange surrounding a first end portion of the membrane structure, a first intermediate portion arranged between a first end surface of the membrane structure and the housing, and a first bonding material interposed between the first flange and the membrane structure and between the first intermediate portion and the membrane structure.

A membrane assembly according to a second aspect of the present invention is a membrane assembly according to the first aspect, in which the first intermediate portion and the first flange are formed as a single piece.

A membrane assembly according to a third aspect of the present invention is a membrane assembly according to the first or second aspect and further includes an annular second flange surrounding a second end portion of the membrane structure, a second intermediate portion arranged between a second end surface of the membrane structure and the housing, and a second bonding material interposed between the second flange and the membrane structure and between the second intermediate portion and the membrane structure.

A membrane assembly according to a fourth aspect of the present invention is a membrane assembly according to the third aspect, in which the second intermediate portion and the second flange are formed as a single piece.

A membrane assembly according to a fifth aspect of the present invention is a membrane assembly according to the first through fourth aspects, in which the first flange is constituted by a ceramic material.

A membrane assembly according to a sixth aspect of the present invention is a membrane assembly according to the first through fifth aspects, in which the second flange is constituted by a ceramic material.

A membrane assembly according to a seventh aspect of the present invention is a membrane assembly according to the first through sixth aspects, in which the membrane structure is a reactor.

A membrane assembly according to an eighth aspect of the present invention is a membrane assembly according to the first through sixth aspects, in which the membrane structure is a separation filter.

A separation membrane module according to a ninth aspect of the present invention includes the membrane assembly according to any one of the first through eighth aspects, and a tubular housing in which the membrane assembly is housed.

According to the present invention, it is possible to provide a separation membrane module that can improve reliability of a seal formed by a bonding material between a flange and a membrane structure.

### BRIEF DESCRIPTION OF DRAWINGS

FIG. 1 is a cross-sectional view of a separation membrane module according to an embodiment.

FIG. 2 is a partial enlarged view of FIG. 1.

FIG. 3 is a partial enlarged view of FIG. 1.

FIG. 4 is a cross-sectional view of a reactor assembly according to an embodiment.

FIG. 5 is a cross-sectional view of a reactor assembly according to a comparative example.

FIG. 6 is a cross-sectional view of a separation membrane module according to Variation 2.

FIG. 7 is a cross-sectional view taken along line A-A shown in FIG. 6.

FIG. 8 is a cross-sectional view taken along line B-B shown in FIG. 6.

FIG. 9 is a cross-sectional view of a separation membrane module according to Variation 4.

FIG. 10 is a cross-sectional view of a separation membrane module according to Variation 4.

FIG. 11 is a cross-sectional view of a separation membrane module according to Variation 6.

FIG. 12 is a cross-sectional view of a separation membrane module according to Variation 6.

FIG. 13 is a cross-sectional view of a separation membrane module according to Variation 7.

FIG. 14 is a cross-sectional view of a separation membrane module according to Variation 7.

FIG. 15 is a cross-sectional view of a separation membrane module according to Variation 7.

FIG. 16 is a cross-sectional view of a separation membrane module according to Variation 8.

FIG. 17 is a cross-sectional view of a separation membrane module according to Variation 8.

FIG. 18 is a cross-sectional view of a separation membrane module according to Variation 9.

FIG. 19 is a cross-sectional view of a separation membrane module according to Variation 9.

FIG. 20 is a cross-sectional view of a separation membrane module according to Variation 9.

### DESCRIPTION OF EMBODIMENTS

### Separation Membrane Module 1

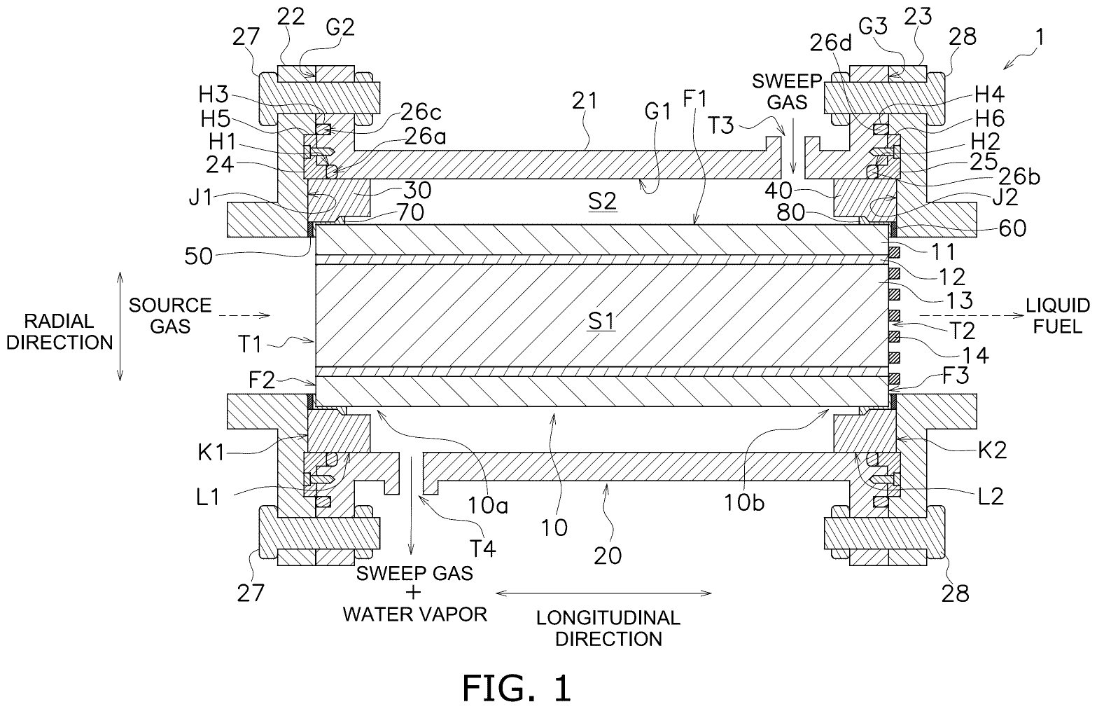

The following describes a separation membrane module 1 according to an embodiment. FIG. 1 is a schematic cross-sectional view showing a configuration of the separation membrane module 1.

As shown in FIG. 1, the separation membrane module 1 includes a reactor 10, a housing 20, a first flange 30, a second flange 40, a first intermediate portion 50, a second intermediate portion 60, a first bonding material 70, and a second bonding material 80. The reactor 10 is an example of a “membrane structure” according to the present invention.

### Reactor 10

The reactor 10 is housed in the housing 20. The reactor 10 is formed into a columnar shape extending in a longitudinal direction. The external shape of the reactor 10 is not particularly limited, and may be a circular column shape, an elliptical column shape, or a polygonal column shape, for example.

The reactor 10 is a so-called membrane reactor for converting a source gas into a liquid fuel. The source gas contains at least hydrogen and carbon oxide. At least one of carbon monoxide and carbon dioxide can be used as the carbon oxide. The source gas may be a so-called synthesis gas (syngas). The liquid fuel is a fuel that is in a liquid state at normal temperature and normal pressure or a fuel that can be liquefied at normal temperature in a pressurized state. Examples of fuels that are in the liquid state at normal temperature and normal pressure include methanol, ethanol, a liquid fuel represented by CₙH₂₍ₘ₋₂ₙ₎ (m is an integer smaller than 90, and n is an integer smaller than 30), and a mixture of these. Examples of fuels that can be liquefied at normal temperature in a pressurized state include propane, butane, and a mixture of these.

For example, a reaction formula (1) for the synthesis of methanol through catalytic hydrogenation of a source gas containing hydrogen and carbon dioxide in the presence of a catalyst is expressed as follows.

$$\begin{matrix}[ Chem . 1 ] & \\ {CO}_{2} + 3 {H}_{2} ⇄ {CH}_{3} OH + {H}_{2} O & ( 1 )\end{matrix}$$

The above reaction is an equilibrium reaction, and the reactor 10 can shift the reaction equilibrium to the product side by separating water vapor, which is one of the products of the conversion reaction. In order to increase the conversion efficiency and the reaction rate, the conversion reaction is preferably carried out at a high temperature and a high pressure (e.g., 180° C. or higher and 2 MPa or higher). The liquid fuel is in a gaseous state when it is synthesized, and remains in the gaseous state at least until the liquid fuel flows out of the reactor 10. It is preferable that the reactor 10 has heat resistance and pressure resistance appropriate for synthesis conditions of the desired liquid fuel.

The reactor 10 according to the present embodiment is a so-called tubular type reactor. As shown in FIG. 1, the reactor 10 includes an outer circumferential surface F1, a first end surface F2, and a second end surface F3. The outer circumferential surface F1 is a side surface of the columnar reactor 10. The outer circumferential surface F1 continues to the first end surface F2 and the second end surface F3. The first end surface F2 is an end surface of the columnar reactor 10. A first opening T1 is formed in the first end surface F2. The source gas flows into the reactor 10 via the first opening T1. The second end surface F3 is another end surface of the columnar reactor 10. A second opening T2 is formed in the second end surface F3. The liquid fuel flows out of the reactor 10 via the second opening T2.

The reactor 10 includes a first end portion 10a and a second end portion 10b. The first end portion 10a is a one end portion of the reactor 10 in the longitudinal direction. The first end portion 10a includes the first end surface F2 described above. The second end portion 10b is another end portion of the reactor 10 in the longitudinal direction. The second end portion 10b includes the second end surface F3 described above.

Here, the reactor 10 is constituted by a porous support 11, a separation membrane 12, a catalyst 13, and a catalyst stopper 14.

The porous support 11 is formed into a tubular shape extending in the longitudinal direction. The porous support 11 is constituted by a porous material. A ceramic material, a metallic material, a resin material, a composite member of these, or the like can be used as the porous material, and a ceramic material is particularly favorable. Alumina (Al₂O₃), titania (TiO₂), mullite (Al₂O₃ and SiO₂), potsherd, cordierite (Mg₂Al₄Si₅O₁₈), a composite material including two or more of these, or the like can be used as an aggregate for the ceramic material. Alumina is favorable in view of availability, clay stability, and corrosion resistance. At least one of titania, mullite, easily sinterable alumina, silica, glass frit, a clay mineral, and easily sinterable cordierite can be used as an inorganic binder for the ceramic material. However, the ceramic material need not necessarily contain an inorganic binder.

The average pore diameter of the porous support 11 can be set to 5 μm or more and 25 μm or less. The average pore diameter of the porous support 11 can be measured using a mercury intrusion method. The porosity of the porous support 11 can be set to 25% or more and 50% or less. The average particle diameter of the porous material can be set to 1 μm or more and 100 μm or less. The average particle diameter refers to the arithmetic mean of the maximum diameters of 30 particles to be measured (randomly selected), as measured by cross-sectional microstructural observation using a scanning electron microscope (SEM).

The separation membrane 12 is supported by the porous support 11. The separation membrane 12 is formed into a tubular shape extending in the longitudinal direction. The inner side of the separation membrane 12 is a non-permeate-side space S1 to which the source gas is supplied. The non-permeate-side space S1 is a space between the first opening T1 and the second opening T2. In the present embodiment, the separation membrane 12 is arranged on the inner surface of the porous support 11, but the separation membrane 12 may be arranged on the outer surface of the porous support 11.

The separation membrane 12 allows water vapor, which is one of the products generated through the conversion reaction for converting the source gas into the liquid fuel, to pass therethrough. Thus, the reaction equilibrium of the above formula (1) can be shifted to the product side by utilizing an equilibrium shift effect.

It is preferable that the separation membrane 12 has a water vapor permeability coefficient of 100 nmol/(s Pa m²) or more. The water vapor permeability coefficient can be obtained using a known method (see Ind. Eng. Chem. Res., 40, 163-175 (2001)).

It is preferable that the separation membrane 12 has a separation coefficient of 100 or more. The larger the separation coefficient is, the separation membrane 12 allows permeation of more water vapor and less components (hydrogen, carbon dioxide, the liquid fuel, etc.) other than water vapor. The separation coefficient can be obtained using a known method (see FIG. 1 in “Separation and Purification Technology 239 (2020) 116533”).

The separation membrane 12 may be an inorganic membrane. Inorganic membranes have heat resistance, pressure resistance, and water vapor resistance and thus are preferable. Examples of inorganic membranes include zeolite membranes, silica membranes, alumina membranes, and composite membranes thereof. In particular, LTA-type zeolite membranes in which a molar ratio (Si/Al) between silicon element (Si) and aluminum element (Al) is 1.0 or more and 3.0 or less have excellent water vapor permeability and thus are favorable.

The catalyst 13 is arranged on the inner side of the separation membrane 12, i.e., in the non-permeate-side space S1. It is preferable that the non-permeate-side space S1 is filled with the catalyst 13, but the catalyst 13 may also be arranged in such a manner as to form a layer or islands on the surface of the separation membrane 12. The catalyst 13 promotes the conversion reaction for converting the source gas into the liquid fuel shown in the above formula (1).

The catalyst 13 may be a known catalyst suitable for the conversion reaction for converting the source gas into the liquid fuel. Examples of the catalyst 13 include metal catalysts (copper, palladium, etc.), oxide catalysts (zinc oxide, zirconia, gallium oxide, etc.), and composites of these (copper-zinc oxide, copper-zinc oxide-alumina, copper-zinc oxide-chromium oxide-alumina, copper-cobalt-titania, and these catalysts modified with palladium, etc.).

The catalyst stopper 14 is attached to the second end surface F3. The catalyst stopper 14 is arranged in such a manner as to cover the second opening T2 formed in the second end surface F3. The catalyst stopper 14 prevents the catalyst 13 from leaking from the second opening T2. The catalyst stopper 14 is configured so as not to prevent the liquid fuel from flowing out, while preventing leakage of the catalyst 13. The catalyst stopper 14 may be a net-like member, a plate having a hole, or the like.

However, in a case where leakage of the catalyst 13 is unlikely to occur (for example, in the case where the catalyst 13 is arranged in such a manner as to form a layer or islands on the surface of the separation membrane 12), the reactor 10 need not be provided with the catalyst stopper 14.

In the reactor 10, the source gas supplied to the non-permeate-side space S1 is converted into the liquid fuel due to the action of the catalyst 13, and water vapor, which is one of the products generated through the conversion reaction, is separated by passing through the separation membrane 12 and the porous support 11 into a permeate-side space S2, which will be described later.

### Housing 20

The housing 20 is formed into a tubular shape as a whole. The housing 20 accommodates the reactor 10. The housing 20 has a structure that can endure the conversion reaction carried out at a high temperature and a high pressure (e.g., 180° C. or higher and 2 MPa or higher). In a case where the source gas and/or sweep gas contains hydrogen, it is preferable that the housing 20 is constituted by a material that is resistant to hydrogen embrittlement. The housing 20 can be constituted mainly by a metallic material (stainless steel or the like).

As shown in FIG. 1, the housing 20 is constituted by a tube main body 21, a first end plate 22, and a second end plate 23.

The tube main body 21 is formed into a tubular shape extending in the longitudinal direction. Both end portions of the tube main body 21 are formed like flanges by increasing the diameter.

The tube main body 21 has an inner circumferential surface G1, a first end surface G2, a second end surface G3, a sweep gas inlet T3, and a sweep gas outlet T4.

The inner circumferential surface G1 faces the outer circumferential surface F1 of the reactor 10 and is spaced apart from the outer circumferential surface F1. The space between the inner circumferential surface G1 and the outer circumferential surface F1 is the permeate-side space S2 for collecting water vapor, which is one of the products generated through the conversion reaction.

An annular first cutout H1 is formed at an end of the inner circumferential surface G1. An annular first elastic member 26a is arranged in the first cutout H1. The first elastic member 26a may be an O-ring made of rubber and may be composed of expanded graphite, for example. The first elastic member 26a is brought into close contact with a first flange 30, which will be described later, by being pressed by a first pressing member 24 that is inserted into the first cutout H1. Thus, a seal is formed between the tube main body 21 and the first flange 30. Note that the first pressing member 24 is fixed to the first end surface G2 of the tube main body 21 with a bolt or the like. In the present embodiment, the first pressing member 24 has an L-shaped cross section.

An annular second cutout H2 is formed at another end of the inner circumferential surface G1. An annular second elastic member 26b is arranged in the second cutout H2. The second elastic member 26b may be an O-ring made of rubber and may be composed of expanded graphite, for example. The second elastic member 26b is brought into close contact with a second flange 40, which will be described later, by being pressed by a second pressing member 25 that is inserted into the second cutout H2. Thus, a seal is formed between the tube main body 21 and the second flange 40. Note that the second pressing member 25 is fixed to the second end surface G3 of the tube main body 21 with a bolt or the like. In the present embodiment, the second pressing member 25 has an L-shaped cross section.

An annular first recess H3 is formed in the first end surface G2. A third elastic member 26c is arranged in the first recess H3. The third elastic member 26c may be an O-ring made of rubber and may be composed of expanded graphite, for example. The third elastic member 26c is in close contact with the first end plate 22.

An annular second recess H4 is formed in the second end surface G3. A fourth elastic member 26d is arranged in the second recess H4. The fourth elastic member 26d may be an O-ring made of rubber and may be composed of expanded graphite, for example. The fourth elastic member 26d is in close contact with the second end plate 23.

Each of the sweep gas inlet T3 and the sweep gas outlet T4 continues to the permeate-side space S2. Sweep gas is supplied via the sweep gas inlet T3 to the permeate-side space S2. In the permeate-side space S2, the sweep gas takes in water vapor and absorbs reaction heat generated through the conversion reaction. The sweep gas is discharged from the sweep gas outlet T4 together with water vapor. Hydrogen and/or carbon dioxide can be used as the sweep gas. Alternatively, inert gas (e.g., nitrogen) or air may be used as the sweep gas. In the present embodiment, the sweep gas inlet T3 and the sweep gas outlet T4 are diagonally opposite to each other in a cross-sectional view, but the positions of the sweep gas inlet T3 and the sweep gas outlet T4 can be suitably changed.

The first end plate 22 is an annular plate member. A center portion of the first end plate 22 is formed like a flange by broadening the width. The first end plate 22 has a first facing surface J1. The first facing surface J1 faces the first end surface F2 of the reactor 10 and an end surface K1 of the first flange 30, which will be described later. However, the first facing surface J1 need not necessarily face the first end surface F2 of the reactor 10. The first facing surface J1 is in contact with the first end surface G2 of the tube main body 21. An annular third recess H5 is formed in the first facing surface J1. A portion of the first pressing member 24 protruding from the first end surface G2 is accommodated in the third recess H5.

The first end plate 22 is connected to the tube main body 21 with use of a plurality of fixing members 27. The fixing members 27 are constituted by a bolt and a nut, for example. The first end plate 22 comes into close contact with the third elastic member 26c. Thus, a seal is formed between the tube main body 21 and the first end plate 22.

The second end plate 23 is an annular plate member. A center portion of the second end plate 23 is formed like a flange by broadening the width. The second end plate 23 has a second facing surface J2. The second facing surface J2 faces the second end surface F3 of the reactor 10 and an end surface K2 of the second flange 40, which will be described later. However, the second facing surface J2 need not necessarily face the second end surface F3 of the reactor 10. The second facing surface J2 is in contact with the second end surface G3 of the tube main body 21. An annular fourth recess H6 is formed in the second facing surface J2. A portion of the second pressing member 25 protruding from the second end surface G3 is accommodated in the fourth recess H6.

The second end plate 23 is connected to the tube main body 21 with use of a plurality of fixing members 28. The fixing members 28 are constituted by a bolt and a nut, for example. The second end plate 23 comes into close contact with the fourth elastic member 26d. Thus, a seal is formed between the tube main body 21 and the second end plate 23.

### First Flange 30

The first flange 30 is attached to the reactor 10. The first flange 30 is bonded to the reactor 10 by the first bonding material 70. The first flange 30 serves as a spacer for forming the permeate-side space S2 between the reactor 10 and the tube main body 21. The first flange 30 is formed into an annular shape. The first flange 30 surrounds the first end portion 10a of the reactor 10. The first flange 30 is fitted into an end portion of the tube main body 21. The first flange 30 supports the first end portion 10a of the reactor 10 at a position spaced apart from the tube main body 21. Thus, the permeate-side space S2 is formed between the reactor 10 and the tube main body 21.

The first flange 30 has the end surface K1, an outer circumferential surface L1, and an inner circumferential surface M1. The end surface K1 is a longitudinally outer surface of the first flange 30. The end surface K1 faces the first facing surface J1 of the first end plate 22. At least a portion of the end surface K1 may be in contact with the first facing surface J1. In the present embodiment, the end surface K1 is a planar surface. The outer circumferential surface L1 is a radially outer surface of the first flange 30. The outer circumferential surface L1 faces the inner circumferential surface G1 of the tube main body 21 and is in close contact with the first elastic member 26a. The outer circumferential surface L1 may be in contact with the inner circumferential surface G1. The inner circumferential surface M1 is on the side opposite to the outer circumferential surface L1.

The first flange 30 is constituted by a dense ceramic material. Examples of the ceramic material include alumina, zirconia, silicon carbide, aluminum nitride, cordierite, and a composite material including two or more of these. The first flange 30 needs to be air-tight and liquid-tight. Accordingly, the porosity of the first flange 30 is preferably 10.0% or less, and more preferably 5.0% or less.

### Second Flange 40

The second flange 40 is attached to the reactor 10. The second flange 40 is bonded to the reactor 10 by the second bonding material 80. The second flange 40 is arranged on the side opposite to the first flange 30. The second flange 40 serves as a spacer for forming the permeate-side space S2 between the reactor 10 and the tube main body 21. The second flange 40 is formed into an annular shape. The second flange 40 surrounds the second end portion 10b of the reactor 10. The second flange 40 is fitted into another end portion of the tube main body 21. The second flange 40 supports the second end portion 10b of the reactor 10 at a position spaced apart from the tube main body 21.

The second flange 40 has the end surface K2, an outer circumferential surface L2, and an inner circumferential surface M2. The end surface K2 is a longitudinally outer surface of the second flange 40. The end surface K2 faces the second facing surface J2 of the second end plate 23. At least a portion of the end surface K2 may be in contact with the second facing surface J2. In the present embodiment, the end surface K2 is a planar surface. The outer circumferential surface L2 is a radially outer surface of the second flange 40. The outer circumferential surface L2 faces the inner circumferential surface G1 of the tube main body 21 and is in close contact with the second elastic member 26b. The outer circumferential surface L2 may be in contact with the inner circumferential surface G1. The inner circumferential surface M2 is on the side opposite to the outer circumferential surface L2.

The second flange 40 is constituted by a dense ceramic material. Examples of the ceramic material include alumina, zirconia, silicon carbide, aluminum nitride, cordierite, and a composite material including two or more of these. The second flange 40 needs to be air-tight and liquid-tight. Accordingly, the porosity of the second flange 40 is preferably 10.0% or less, and more preferably 5.0% or less.

### First Intermediate Portion 50

The first intermediate portion 50 is an annular thin plate member. The first intermediate portion 50 is bonded to the reactor 10 by the first bonding material 70.

The first intermediate portion 50 is arranged between the reactor 10 and the housing 20. Specifically, the first intermediate portion 50 is arranged between the first end surface F2 of the reactor 10 and the first facing surface J1 of the first end plate 22.

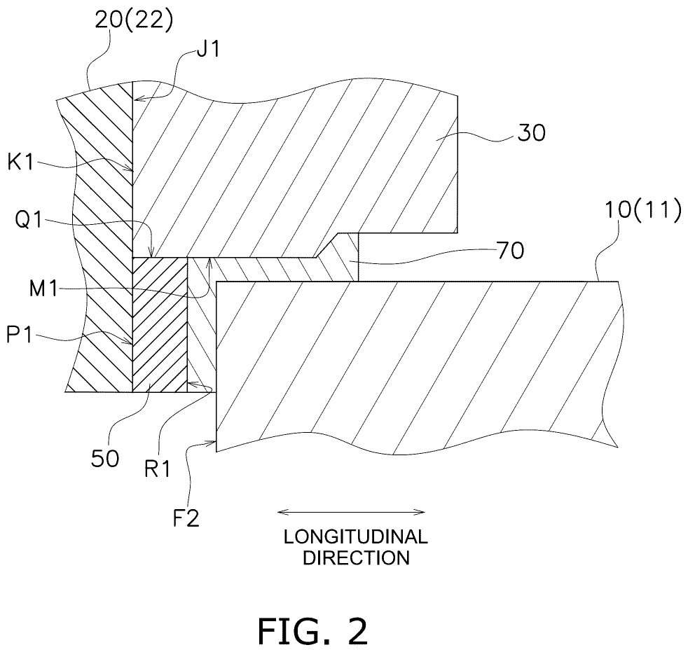

Here, FIG. 2 is a partial enlarged view of FIG. 1. As shown in FIG. 2, the first intermediate portion 50 has a facing surface P1, a contact surface Q1, and a bonded surface R1.

The facing surface P1 faces the housing 20. The facing surface P1 may be in contact with the facing surface J1 of the first end plate 22. In the present embodiment, the facing surface P1 is flush with the end surface K1 of the first flange 30, but a step may be formed between the facing surface P1 and the end surface K1. The contact surface Q1 is in contact with the first flange 30. The contact surface Q1 is in contact with the inner circumferential surface M1 of the first flange 30. The bonded surface R1 is bonded to the first bonding material 70. In the present embodiment, the facing surface P1, the contact surface Q1, and the bonded surface R1 are planar surfaces, but at least one of these may be entirely or partially curved or bent.

### Second Intermediate Portion 60

The second intermediate portion 60 is an annular thin plate member. The second intermediate portion 60 is bonded to the reactor 10 by the second bonding material 80.

The second intermediate portion 60 is arranged between the reactor 10 and the housing 20. Specifically, the second intermediate portion 60 is arranged between the second end surface F3 of the reactor 10 and the second facing surface J2 of the second end plate 23.

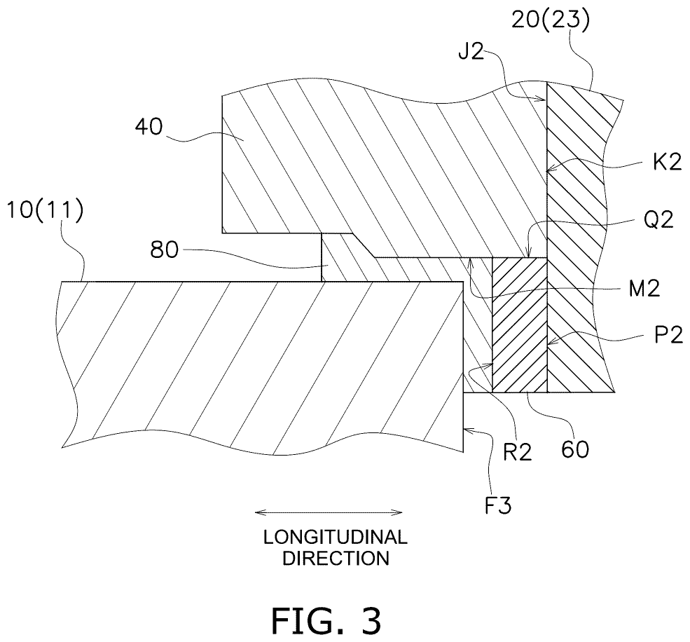

Here, FIG. 3 is a partial enlarged view of FIG. 1. As shown in FIG. 3, the second intermediate portion 60 has a facing surface P2, a contact surface Q2, and a bonded surface R2.

The facing surface P2 faces the housing 20. The facing surface P2 may be in contact with the facing surface J2 of the second end plate 23. In the present embodiment, the facing surface P2 is flush with the end surface K2 of the second flange 40, but a step may be formed between the facing surface P2 and the end surface K2. The contact surface Q2 is in contact with the second flange 40. The contact surface Q2 is in contact with the inner circumferential surface M2 of the second flange 40. The bonded surface R2 is bonded to the second bonding material 80. In the present embodiment, the facing surface P2, the contact surface Q2, and the bonded surface R2 are planar surfaces, but at least one of these may be entirely or partially curved or bent.

### First Bonding Material 70

The first bonding material 70 is interposed between the first flange 30 and the reactor 10 and between the first intermediate portion 50 and the reactor 10. The first bonding material 70 bonds the first flange 30 and the reactor 10, and the first bonding material 70 bonds the first intermediate portion 50 and the reactor 10. The first bonding material 70 is arranged in at least a portion of a space between the first flange 30 and the reactor 10 and at least a portion of a space between the first intermediate portion 50 and the reactor 10. As shown in FIG. 2, the first bonding material 70 has an L-shaped cross section.

Note that a bonded body constituted by the first flange 30 and the reactor 10 bonded together by the first bonding material 70 corresponds to a “membrane assembly” according to the present invention.

Crystallized glass, amorphous glass, a brazing material, ceramics, or the like can be used as the first bonding material 70, and crystallized glass is particularly preferable in view of heat resistance and pressure resistance.

As the crystallized glass, it is possible to use SiO₂—B₂O₃-based, SiO₂—CaO-based, SiO₂—Al₂O₃-based, SiO₂—MgO-based, SiO₂—ZnO—BaO-based, SiO₂—B₂O₃—CaO-based, SiO₂—MgO—CaO-based, SiO₂—Al₂O₃—B₂O₃-based, or SiO₂—MgO—Al₂O₃-based crystallized glass, for example. Note that “crystallized glass” referred to in the present specification means glass in which a percentage of “the volume of a crystal phase” to the whole volume (i.e., degree of crystallinity) is 60% or more and a percentage of “the volume of an amorphous phase and impurities” to the whole volume is less than 40%.

### Second Bonding Material 80

The second bonding material 80 is interposed between the second flange 40 and the reactor 10 and between the second intermediate portion 60 and the reactor 10. The second bonding material 80 bonds the second flange 40 and the reactor 10, and the second bonding material 80 bonds the second intermediate portion 60 and the reactor 10. The second bonding material 80 is arranged in at least a portion of a space between the second flange 40 and the reactor 10 and at least a portion of a space between the second intermediate portion 60 and the reactor 10. As shown in FIG. 3, the second bonding material 80 has an L-shaped cross section.

Note that a bonded body constituted by the second flange 40 and the reactor 10 bonded together by the second bonding material 80 corresponds to the “membrane assembly” according to the present invention.

Crystallized glass, amorphous glass, a brazing material, ceramics, or the like can be used as the second bonding material 80, and crystallized glass is particularly preferable in view of heat resistance and pressure resistance.

### Assembly of Separation Membrane Module 1

Steps for assembling the separation membrane module 1 include: a step of producing a reactor assembly by bonding the first and second flanges 30 and 40 and the first and second intermediate portions 50 and 60 to the reactor 10; and a step of housing the reactor assembly in the housing 20.

The step of producing a reactor assembly includes: a first step of forming molded bodies of the bonding materials; a second step of attaching the flanges and the intermediate portions; and a third step of heating the molded bodies of the bonding materials. In the first step, a molded body of the first bonding material 70 is formed on the first end portion 10a of the reactor 10, and a molded body of the second bonding material 80 is formed on the second end portion 10b of the reactor 10. In the second step, the first flange 30 and the first intermediate portion 50 are attached in such a manner as to surround the molded body of the first bonding material 70, and the second flange 40 and the second intermediate portion 60 are attached in such a manner as to surround the molded body of the second bonding material 80. In the third step, the molded bodies of the first and second bonding materials 70 and 80 are heated to cause crystal growth or melting, and thereafter cooled to room temperature, and thus the first and second bonding materials 70 and 80 are formed. Through the above steps, the reactor assembly in which the first and second flanges 30 and 40 and the first and second intermediate portions 50 and 60 are bonded with the reactor 10 via the first and second bonding materials 70 and 80 is completed.

Next, the step of housing the reactor assembly includes: a fourth step of inserting the reactor assembly; a fifth step of attaching the elastic members; and a sixth step of connecting the end plates. In the fourth step, after the reactor assembly is inserted into the tube main body 21, positioning of both ends of the reactor assembly is performed. In the fifth step, the first and second elastic members 26a and 26b fitted into the first and second cutouts H1 and H2 in the tube main body 21 are pressed by the first and second pressing members 24 and 25, and the third and fourth elastic members 26c and 26d are fitted into the first and second recesses H3 and H4 in the tube main body 21. In the sixth step, the first end plate 22 is connected to the tube main body 21 with use of the fixing members 27, and the second end plate 23 is connected to the tube main body 21 with use of the fixing members 28. Thus, the separation membrane module 1 in which the reactor assembly is housed in the housing 20 is completed.

Here, when the molded body of the first bonding material 70 is heated in the third step, internal stress is not generated in each of the first flange 30, the first bonding material 70, and the reactor 10. When the temperature is thereafter reduced to room temperature, internal stress may remain in the first bonding material 70. The internal stress is a concept that encompasses stress generated inside the first bonding material 70 and stress generated at the interface between the first flange 30 and the first bonding material 70 and the interface between the reactor 10 and the first bonding material 70 (in particular, at the interface between the reactor 10 and the first bonding material 70).

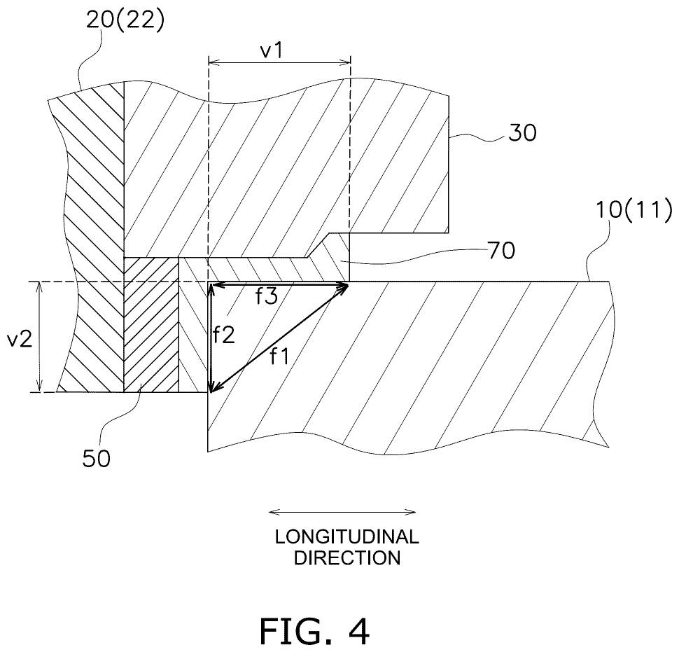

In the present embodiment, the separation membrane module 1 includes: the first intermediate portion 50 arranged between the reactor 10 and the housing 20; and the first bonding material 70 interposed between the first flange 30 and the reactor 10 and between the first intermediate portion 50 and the reactor 10, as described above. Therefore, as shown in FIG. 4, an internal stress f1 is applied to the first bonding material 70 in a direction inclined with respect to the longitudinal direction. The internal stress f1 is a composite stress of an internal stress f2 applied in the radial direction and an internal stress f3 applied in the longitudinal direction. Note that a total seal length of the first bonding material 70 is the sum of a seal length v1 in the longitudinal direction and a seal length v2 in the radial direction. The total seal length of the first bonding material 70 is a seal length that is necessary to assure seal characteristics between the first flange 30 and the reactor 10.

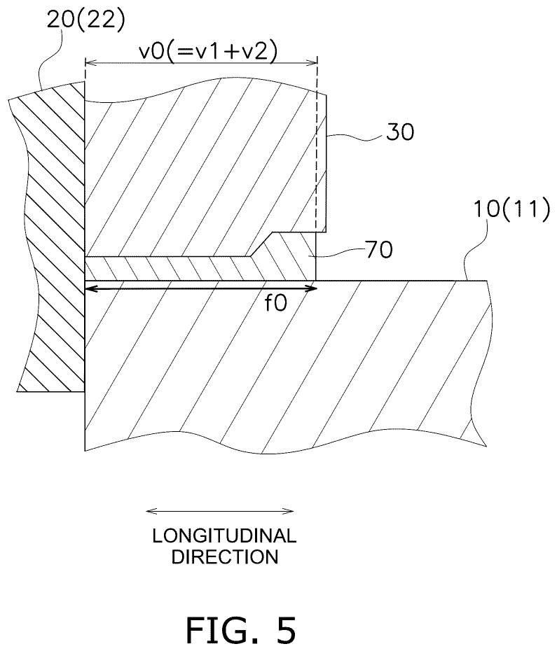

On the other hand, if the separation membrane module 1 does not include the first intermediate portion 50, a seal length v0 that is equal to the sum of the seal length v1 and the seal length v2 is necessary as the total seal length of the first bonding material 70 as shown in FIG. 5 in order to assure seal characteristics equivalent to those achieved by the first bonding material 70 shown in FIG. 4. In this case, an internal stress f0 that is larger than the internal stress f1 shown in FIG. 4 is applied to the first bonding material 70.

As described above, if the total seal length of the first bonding material 70 is the same, internal stress applied to the first bonding material 70 can be reduced in the case where the intermediate portion 50 is provided, compared with a case where the intermediate portion 50 is not provided. Accordingly, it is possible to improve reliability of the seal formed by the first bonding material 70 between the first flange 30 and the reactor 10.

Note that situations in which internal stress is applied to the first bonding material 70 are not limited to the third step described above. For example, internal stress is applied to the first bonding material 70 when the source gas is supplied with a high pressure. Therefore, the effect of improving reliability of the seal formed by the first bonding material 70 can also be obtained in cases where internal stress does not remain in the first bonding material 70.

The above-described effect can be obtained in the same manner as for the relationship between the second flange 40, the second bonding material 80, and the reactor 10.

### Variations of Embodiment

Although an embodiment of the present invention has been described, the present invention is not limited to the above embodiment, and various changes can be made within a scope not departing from the gist of the present invention.

### Variation 1

In the above embodiment, a case where the reactor 10 is used as the membrane structure is described, but a separation filter may also be used as the membrane structure. The separation filter has a configuration similar to that of the reactor 10, except that a separation membrane that allows a desired component contained in a fluid mixture to pass therethrough is used instead of the separation membrane 12 that allows water vapor to pass therethrough, and that the separation filter does not include the catalyst 13. In the case where the separation filter is used as the membrane structure as well, use of the separation filter under high-temperature and high-pressure conditions is assumed in the present invention.

Note that in the case where the separation filter is used as the membrane structure, reaction heat is not generated and the need to control the temperature is low. Accordingly, a component that has passed through the separation membrane may be discharged from the sweep gas outlet T4 by making the pressure on the sweep gas outlet T4 side lower than the pressure on the sweep gas inlet T3 side.

### Variation 2

In the above embodiment, the tubular type reactor 10 is described as an example of the membrane structure, but it is also possible to use a monolith type reactor. Also, in the case where a separation filter is used as the membrane structure, either a tubular type separation filter or a monolith type separation filter may be used. The monolith type is a concept that encompasses a honeycomb type and means a shape that includes a plurality of cells extending through the membrane structure in the longitudinal direction.

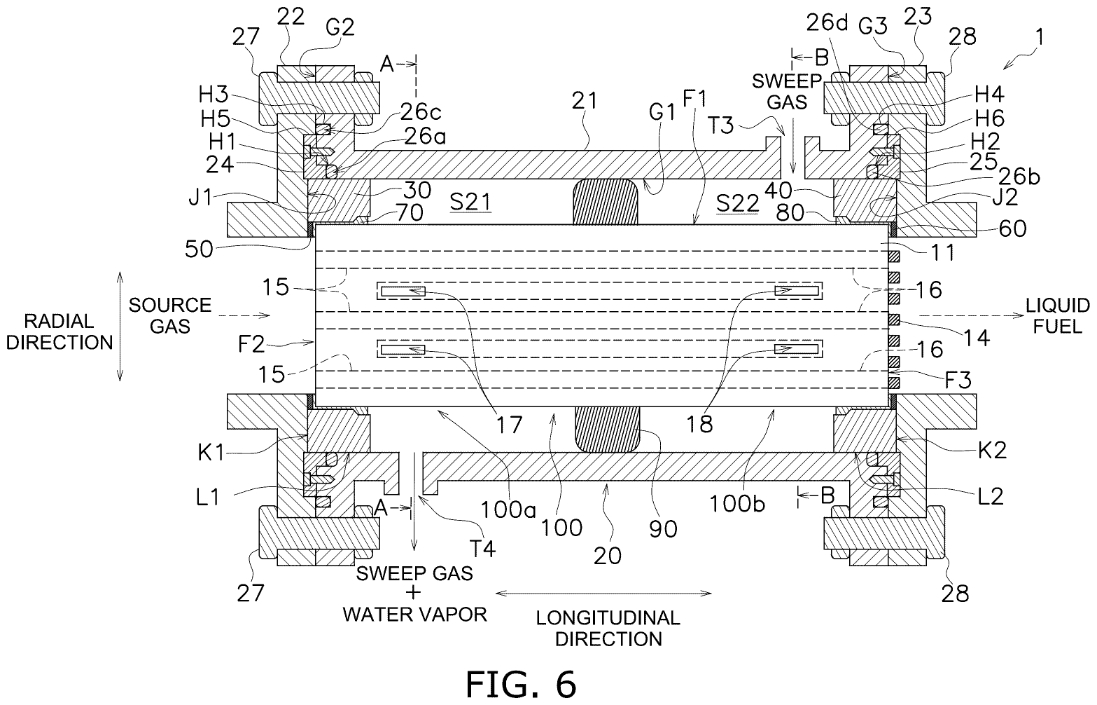

FIG. 6 is a schematic cross-sectional view showing a configuration of a separation membrane module 1a that includes a monolith type reactor 100. Note that only the reactor 100 is shown in a side view in FIG. 6.

The separation membrane module 1a is the same as the separation membrane module 1 according to the above embodiment, except that the separation membrane module 1a further includes a flow stopper 90, and includes the reactor 100 instead of the reactor 10. Note that the catalyst stopper 14 is optionally provided in the reactor 100 as well.

The flow stopper 90 is formed into an annular shape. The flow stopper 90 is arranged between the reactor 100 and the housing 20. The flow stopper 90 partitions the space between the reactor 100 and the housing 20 into a first permeate-side space S21 and a second permeate-side space S22. The flow stopper 90 suppresses a direct flow of sweep gas between the first permeate-side space S21 and the second permeate-side space S22. The flow stopper 90 is only required to be capable of suppressing a direct flow of sweep gas between these spaces, and need not serve as a seal between the reactor 100 and the housing 20. The flow stopper 90 can be made of expanded graphite, rubber, resin, metal, or the like.

The reactor 100 includes a plurality of first flow paths 15, a plurality of second flow paths 16, first slits 17, and second slits 18.

The first flow paths 15 extend through the reactor 100 in the longitudinal direction. The first flow paths 15 are open in the first and second end surfaces F2 and F3. The separation membrane 12 described above is formed on the inner surface of each first flow path 15. The inner side of the separation membrane 12 is the non-permeate-side space S1. The catalyst 13 described above is arranged in the non-permeate-side space S1.

The second flow paths 16 are provided inside the reactor 100. The second flow paths 16 extend in the longitudinal direction. The second flow paths 16 are closed in the first and second end surfaces F2 and F3.

The first slits 17 are formed in a first end portion 100a of the reactor 100. The first slits 17 extend through each second flow path 16 in the radial direction and are open in the outer circumferential surface F1. Accordingly, the first slits 17 communicate with each second flow path 16 and the first permeate-side space S21.

The second slits 18 are formed in a second end portion 100b of the reactor 100. The second slits 18 extend through each second flow path 16 in the radial direction and are open in the outer circumferential surface F1. Accordingly, the second slits 18 communicate with each second flow path 16 and the second permeate-side space S22.

When the source gas is supplied to the first flow paths 15, the source gas is converted into the liquid fuel due to the action of the catalyst 13, and water vapor, which is one of the products of the conversion reaction, passes through the separation membrane 12 and flows into the second flow paths 16. Water vapor that has flowed into the second flow paths 16 is taken into sweep gas flowing into the second flow paths 16 from the sweep gas inlet T3 via the second permeate-side space S22 and the second slits 18, and thereafter is discharged from the sweep gas outlet T4 to the outside via the first slits 17 and the first permeate-side space S21.

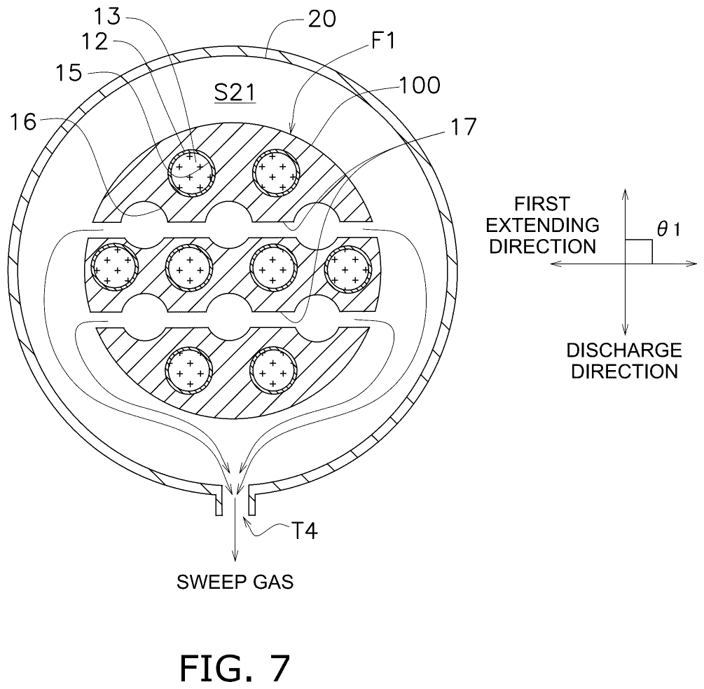

Here, FIG. 7 is a cross-sectional view taken along line A-A shown in FIG. 6. As shown in FIG. 7, the first slits 17 linearly extend through the inside of the reactor 100 and are open on both sides of the reactor 100. Each first slit 17 includes two openings formed in the outer circumferential surface F1. Sweep gas that has flowed out from the two openings of the first slit 17 to the first permeate-side space S21 passes through the first permeate-side space S21 and is discharged from the sweep gas outlet T4 to the outside.

Here, a first extending direction of each first slit 17 extending inside the reactor 100 is preferably inclined with respect to a discharge direction of the sweep gas discharged from the sweep gas outlet T4 to the outside, or the first extending direction is preferably orthogonal to the discharge direction. Specifically, an angle θ1 of the first extending direction relative to the discharge direction is preferably 45° or more and 135° or less. With this configuration, it is possible to suppress maldistribution of gas flows from the openings of the first slits 17 toward the sweep gas outlet T4, and accordingly, it is possible to suppress maldistribution of flows of sweep gas in the first permeate-side space S21.

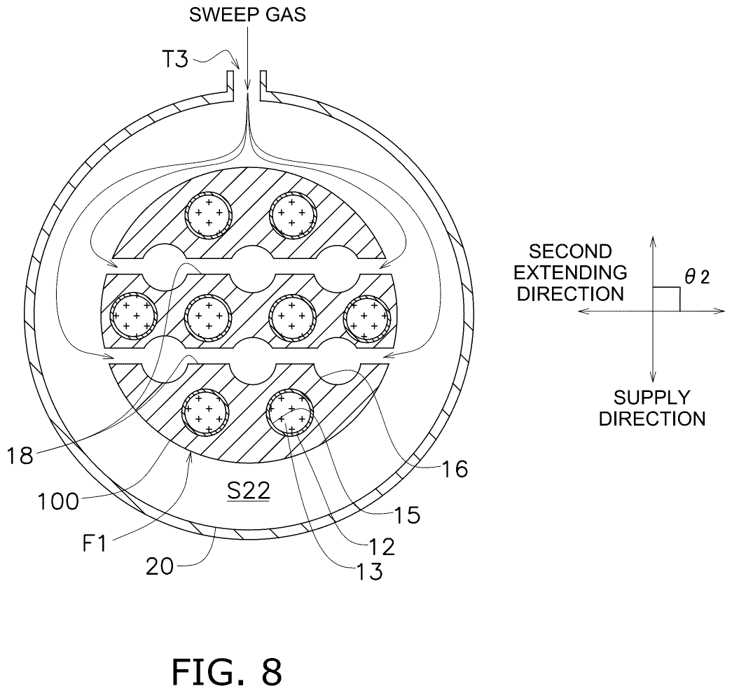

FIG. 8 is a cross-sectional view taken along line B-B shown in FIG. 6. As shown in FIG. 8, the second slits 18 linearly extend through the inside of the reactor 100 and are open on both sides of the reactor 100. Each second slit 18 includes two openings formed in the outer circumferential surface F1. Sweep gas supplied from the sweep gas inlet T3 to the second permeate-side space S22 passes through the second permeate-side space S22 and flows into the two openings of the second slit 18.

Here, a second extending direction of each second slit 18 extending inside the reactor 100 is preferably inclined with respect to a supply direction of the sweep gas supplied from the sweep gas inlet T3 to the second permeate-side space S22, or the second extending direction is preferably orthogonal to the supply direction. Specifically, an angle θ2 of the second extending direction relative to the supply direction is preferably 45° or more and 135° or less. With this configuration, it is possible to suppress maldistribution of gas flows from the sweep gas inlet T3 toward the openings of the second slits 18, and accordingly, it is possible to suppress maldistribution of flows of sweep gas in the second permeate-side space S22.

### Variation 3

In the above embodiment, the separation membrane 12 is in contact with the catalyst 13, but a buffer layer may be interposed between the separation membrane 12 and the catalyst 13. The buffer layer physically separates the catalyst 13 from the separation membrane 12, and therefore, when the catalyst 13 has a high temperature due to reaction heat, it is possible to suppress generation of a crack in the separation membrane 12 from a point that is in contact with the catalyst 13. The buffer layer can be constituted by a ceramic material or an organic polymer material. Examples of ceramic materials that can be used include silica, alumina, and chromia. Examples of organic polymer materials that can be used include PTFE, PVA, and PEG.

### Variation 4

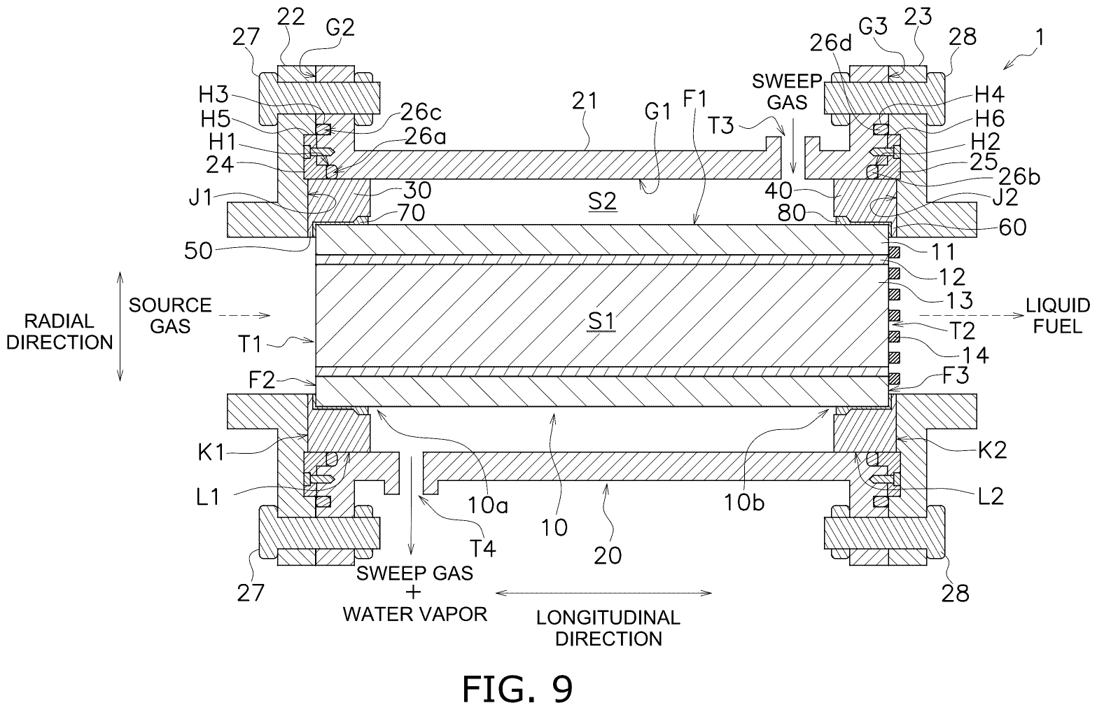

In the above embodiment, the first flange 30 is formed separately from the first intermediate portion 50, but the first flange 30 and the first intermediate portion 50 may be formed as a single piece as shown in FIG. 9. In the case where the first flange 30 and the first intermediate portion 50 are formed as a single piece, handleability can be improved in the steps for assembling the separation membrane module 1.

Likewise, in the above embodiment, the second flange 40 is formed separately from the second intermediate portion 60, but the second flange 40 and the second intermediate portion 60 may be formed as a single piece as shown in FIG. 9.

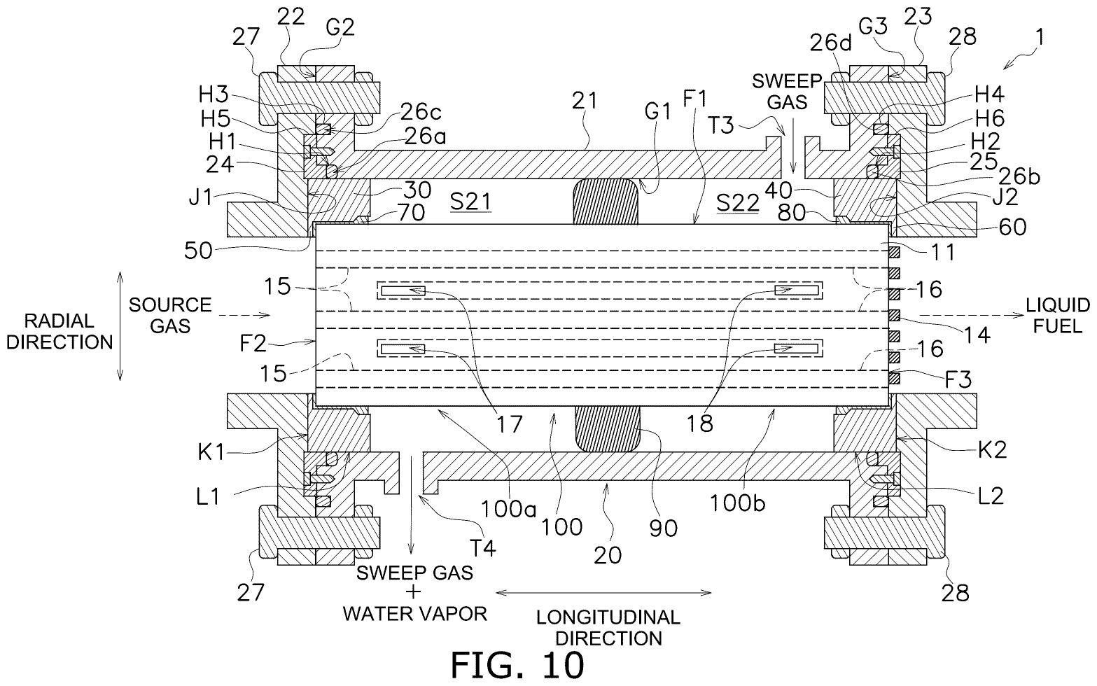

In the case where the monolith type membrane structure described above in Variation 2 is used as well, the first flange 30 and the first intermediate portion 50 may be formed as a single piece and the second flange 40 and the second intermediate portion 60 may be formed as a single piece as shown in FIG. 10.

### Variation 5

In the above embodiment, the separation membrane 12 allows water vapor, which is one of the products of the conversion reaction for converting the source gas into the liquid fuel, to pass therethrough, but there is no limitation to this configuration. The separation membrane 12 may allow the liquid fuel generated through the conversion reaction for converting the source gas into the liquid fuel to pass therethrough. In this case as well, the reaction equilibrium of the above formula (1) can be shifted to the product side.

Also, in the case where the separation membrane 12 allows the liquid fuel to pass therethrough, the reaction equilibrium can be shifted to the product side even when the liquid fuel is generated through a reaction in which no water vapor is generated (For example, see formula (2) below).

[Chem. 2]

2H₂+CO [symbol] CH₃OH (2)

### Variation 6

In the separation membrane module 1 (see FIG. 1) according to the above embodiment, the sweep gas inlet T3 and the sweep gas outlet T4 are diagonally opposite to each other in a side view, and sweep gas flows from the sweep gas inlet T3 toward the sweep gas outlet T4, but there is no limitation to this configuration.

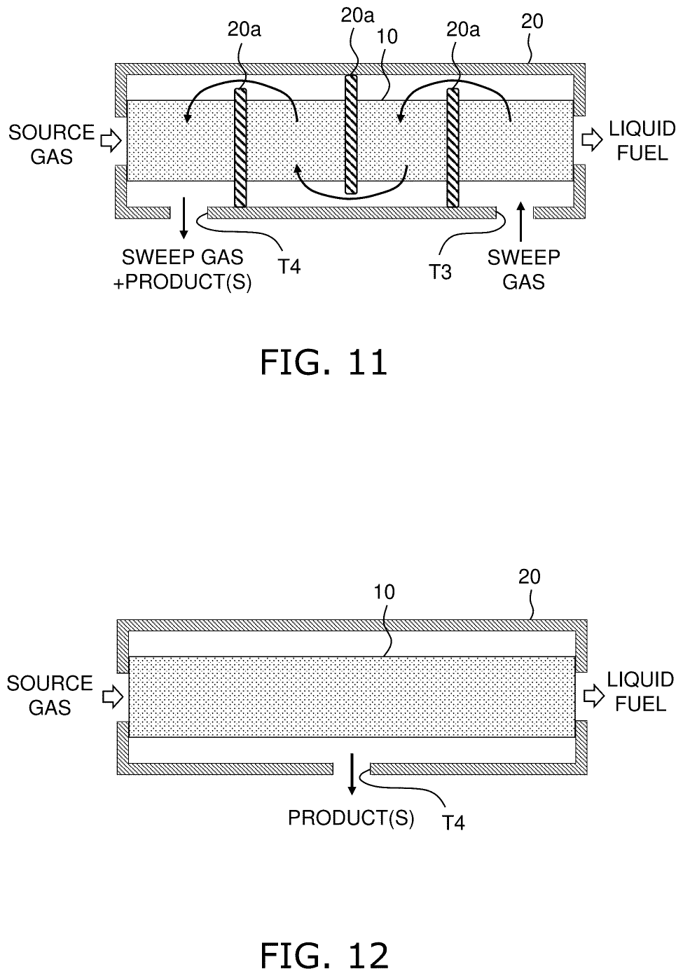

For example, as shown in FIG. 11, the sweep gas inlet T3 and the sweep gas outlet T4 may be provided on the same side of the reactor 10 in a side view, and flow regulation plates 20a that partially block the space between the reactor 10 and the housing 20 may be provided. Three flow regulation plates 20a are provided in the example shown in FIG. 11, but the number of flow regulation plates 20a may be one, two, or four or more. Positions of the flow regulation plates 20a can be suitably set.

As shown in FIG. 12, a configuration is also possible in which the housing 20 does not have the sweep gas inlet T3, and sweep gas is not supplied into the housing 20. In this case, a product/products separated by the separation membrane 12 of the reactor 10 flows out from the sweep gas outlet T4 to the outside of the housing 20. The position of the sweep gas outlet T4 can be suitably set.

Note that the configurations shown in FIGS. 11 and 12 are also applicable to the case where a separation filter is used as the membrane structure instead of the reactor 10.

### Variation 7

In the separation membrane module 1 (see FIG. 1) according to the above embodiment, only one reactor 10 is housed in the housing 20, but there is no limitation to this configuration.

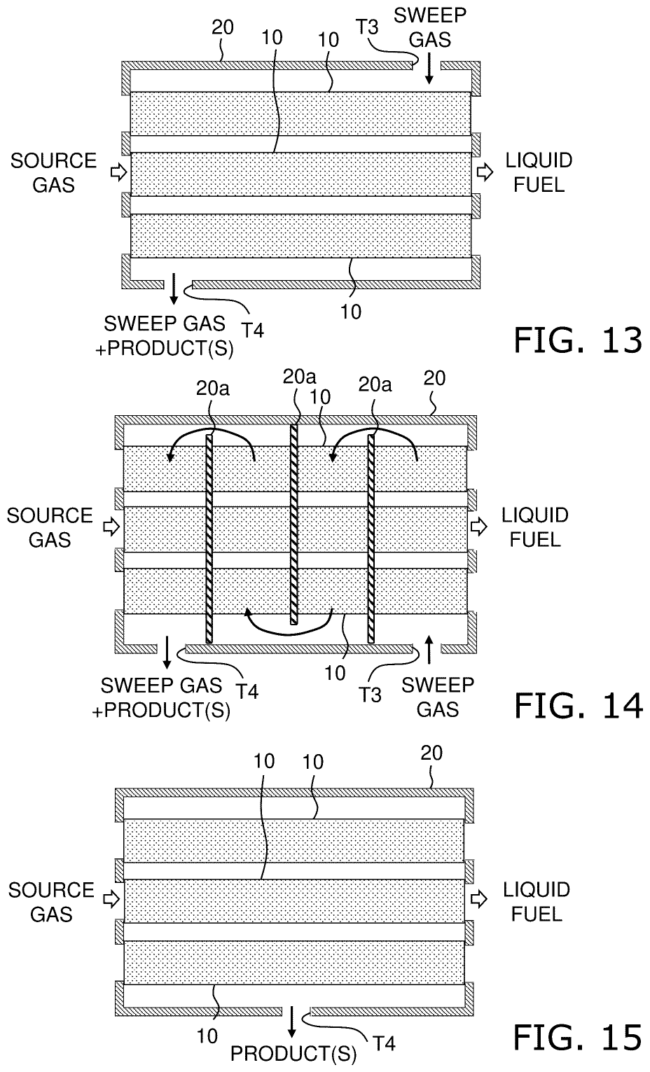

For example, a plurality of reactors 10 may be housed in the housing 20 as shown in FIG. 13.

Also, flow regulation plates 20a that partially block the space between the reactors 10 and the housing 20 may be provided as shown in FIG. 14. Three flow regulation plates 20a are provided in the example shown in FIG. 14, but the number of flow regulation plates 20a may be one, two, or four or more. Positions of the flow regulation plates 20a can be suitably set. Note that the sweep gas inlet T3 and the sweep gas outlet T4 may be provided on the same side of the reactors 10 in a side view as shown in FIG. 14.

As shown in FIG. 15, a configuration is also possible in which the housing 20 does not have the sweep gas inlet T3, and sweep gas is not supplied into the housing 20. In this case, a product/products separated by the separation membranes 12 of the reactors 10 flows out from the sweep gas outlet T4 to the outside of the housing 20. The position of the sweep gas outlet T4 can be suitably set.

Note that the configurations shown in FIGS. 13 to 15 are also applicable to a case where separation filters are used as the membrane structures instead of the reactors 10.

### Variation 8

In the separation membrane module 1a (see FIG. 6) according to Variation 2 described above, the sweep gas inlet T3 and the sweep gas outlet T4 are diagonally opposite to each other in a side view, but there is no limitation to this configuration.

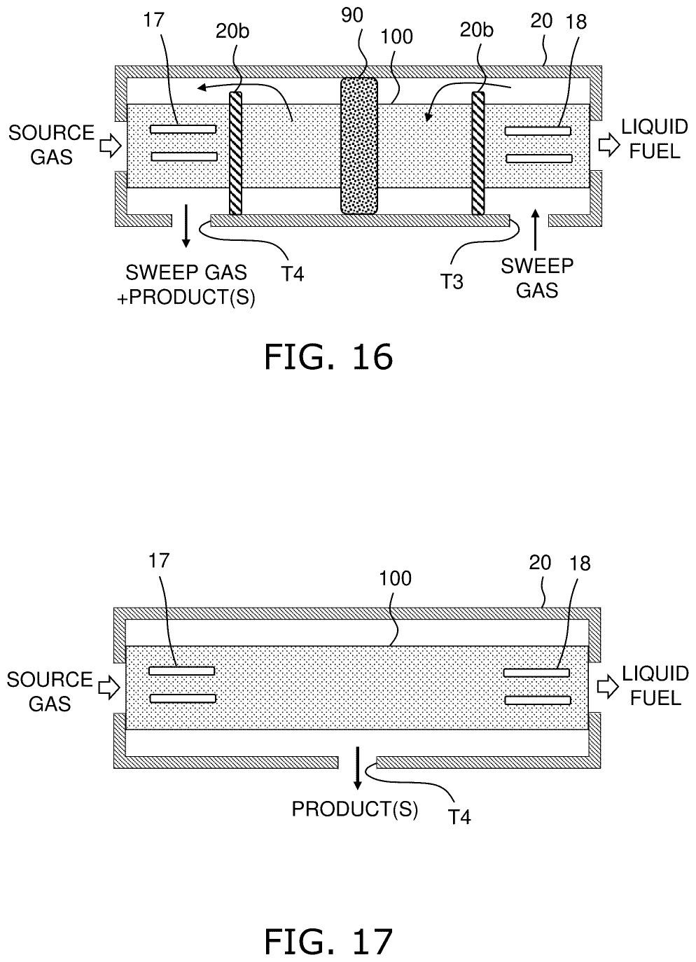

For example, as shown in FIG. 16, the sweep gas inlet T3 and the sweep gas outlet T4 may be provided on the same side of the reactor 100 in a side view, and flow regulation plates 20b that partially block the space between the reactor 100 and the housing 20 may be provided. In the example shown in FIG. 16, a flow regulation plate 20b is provided on each side of the flow stopper 90. The sweep gas inlet T3-side flow regulation plate 20b divides the sweep gas inlet T3-side space into a space in which sweep gas mainly flows into the second slits 18 in the reactor 100 and a space in which sweep gas flows into the reactor 100 from its side surface. The sweep gas outlet T4-side flow regulation plate 20b divides the sweep gas outlet T4-side space into a space in which sweep gas mainly flows out from the first slits 17 in the reactor 100 and a space in which sweep gas flows out from the side surface of the reactor 100. However, the number and positions of flow regulation plates 20b can be suitably set. Also, a portion of sweep gas may pass through the flow stopper 90.

As shown in FIG. 17, a configuration is also possible in which the housing 20 does not have the sweep gas inlet T3, and sweep gas is not supplied into the housing 20. In this case, a product/products separated by the separation membrane 12 of the reactor 100 flows out from the sweep gas outlet T4 to the outside of the housing 20. The position of the sweep gas outlet T4 can be suitably set.

Note that the configurations shown in FIGS. 16 and 17 are also applicable to a case where a separation filter is used as the membrane structure instead of the reactor 100.

### Variation 9

In the separation membrane module 1a (see FIG. 6) according to Variation 2 described above, only one reactor 100 is housed in the housing 20, but there is no limitation to this configuration.

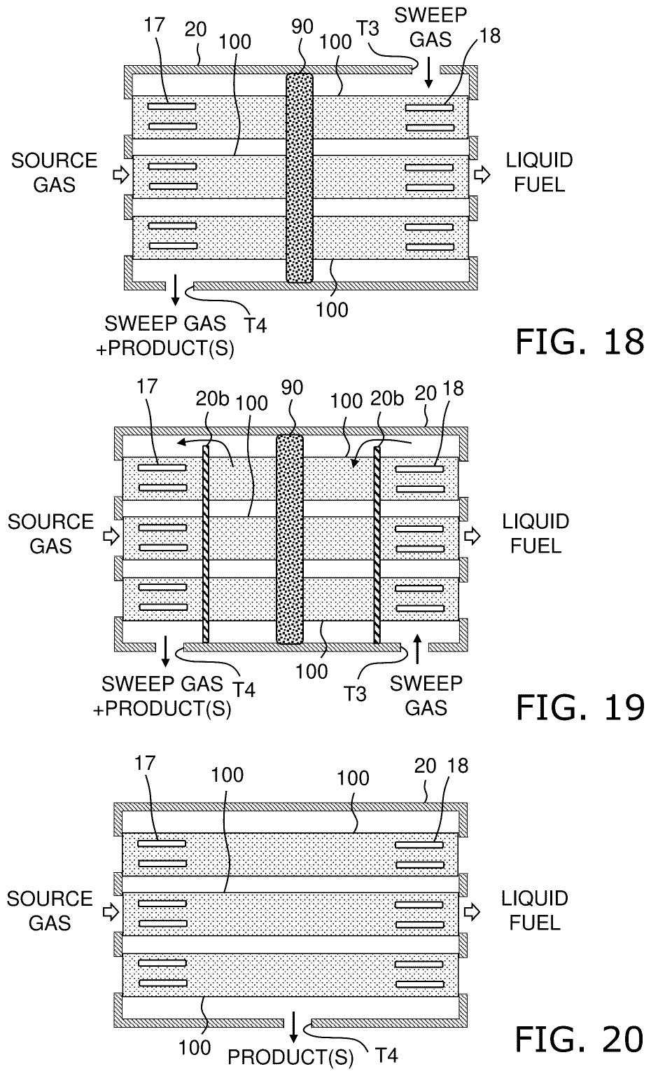

For example, a plurality of reactors 100 may be housed in the housing 20 as shown in FIG. 18.

Also, flow regulation plates 20b that partially block the space between the reactors 100 and the housing 20 may be provided as shown in FIG. 19. In the example shown in FIG. 19, a flow regulation plate 20b is provided on each side of the flow stopper 90. The sweep gas inlet T3-side flow regulation plate 20b divides the sweep gas inlet T3-side space into a space in which sweep gas mainly flows into the second slits 18 in the reactors 100 and a space in which sweep gas flows into the reactors 100 from their side surfaces. The sweep gas outlet T4-side flow regulation plate 20b divides the sweep gas outlet T4-side space into a space in which sweep gas mainly flows out from the first slits 17 in the reactors 100 and a space in which sweep gas flows out from the side surfaces of the reactors 100. However, the number and positions of flow regulation plates 20b can be suitably set. Also, a portion of sweep gas may pass through the flow stopper 90. Note that the sweep gas inlet T3 and the sweep gas outlet T4 may be provided on the same side of the reactors 100 in a side view as shown in FIG. 19.

As shown in FIG. 20, a configuration is also possible in which the housing 20 does not have the sweep gas inlet T3, and sweep gas is not supplied into the housing 20. In this case, a product/products separated by the separation membranes 12 of the reactors 100 flows out from the sweep gas outlet T4 to the outside of the housing 20. The position of the sweep gas outlet T4 can be suitably set.

Note that the configurations shown in FIGS. 18 to 20 are also applicable to a case where separation filters are used as the membrane structures instead of the reactors 100.

### REFERENCE SIGNS LIST

1 Separation membrane module
10 Reactor
10a First end portion
10b Second end portion
20 Housing
G1 Inner circumferential surface
J1 First facing surface
J2 Second facing surface
21 Tube main body
22 First end plate
23 Second end plate
30 First flange
K1 End surface
L1 Outer circumferential surface
M1 Inner circumferential surface
40 Second flange
K2 End surface
L2 Outer circumferential surface
M2 Inner circumferential surface
50 First intermediate portion
P1 Facing surface
Q1 Contact surface
R1 Joined surface
60 Second intermediate portion
P2 Facing surface
Q2 Contact surface
R2 Joined surface
70 First bonding material
80 Second bonding material

1. A membrane assembly configured to be housed in a tubular housing, the membrane assembly comprising:
a columnar membrane structure;
an annular first flange surrounding a first end portion of the membrane structure;
a first intermediate portion arranged between a first end surface of the membrane structure and the housing; and
a first bonding material interposed between the first flange and the membrane structure and between the first intermediate portion and the membrane structure.

2. The membrane assembly according to claim 1, wherein
the first intermediate portion and the first flange are formed as a single piece.

3. The membrane assembly according to claim 1, further comprising:
an annular second flange surrounding a second end portion of the membrane structure;
a second intermediate portion arranged between a second end surface of the membrane structure and the housing; and
a second bonding material interposed between the second flange and the membrane structure and between the second intermediate portion and the membrane structure.

4. The membrane assembly according to claim 3, wherein
the second intermediate portion and the second flange are formed as a single piece.

5. The membrane assembly according to claim 1, wherein
the first flange is constituted by a ceramic material.

6. The membrane assembly according to claim 3, wherein
the second flange is constituted by a ceramic material.

7. The membrane assembly according to claim 1, wherein
the membrane structure is a reactor.

8. The membrane assembly according to claim 1, wherein
the membrane structure is a separation filter.

9. A separation membrane module comprising:
the membrane assembly according to claim 1; and
a tubular housing in which the membrane assembly is housed.
